(19) United States
(12) Patent Application Publication
(10) Pub. No.: US 2026/0030768 A1
(43) Pub. Date: Jan. 29, 2026

(54) IMAGE PROCESSING SYSTEM AND METHOD FOR PROCESSING CAMERA IMAGES

(71) Applicant: Intel Corporation, Santa Clara, CA (US)

(72) Inventors: Fabian OBORIL, Karlsruhe (DE); Cornelius BUERKLE, Karlsruhe (DE)

(21) Appl. No.: 19/200,711

(22) Filed: May 7, 2025

(30) Foreign Application Priority Data
Jul. 23, 2024 (DE) 10 2024 120 894.5

(51) Int. Cl. G06T 7/50; G06T 5/50; G06T 7/70; G06V 10/74; H04N 23/73

(52) U.S. Cl. CPC G06T 7/50; G06T 5/50; G06T 7/70; G06V 10/761; H04N 23/73; G06T 2207/10028; G06T 2207/20221

(57) ABSTRACT

According to one aspect of the present disclosure, an image processing system is provided, comprising a memory and a processor, wherein the processor is configured to determine a depth image from at least two camera images of a scene, to determine at least one area in the depth image where depth information is insufficient, for the at least one determined area in the depth image where depth information is insufficient, to determine, for each of the at least two camera images, a camera image area of the camera image that corresponds to the determined area in the depth image where depth information is insufficient, to perform a matching of at least parts of the determined camera image areas, to determine a cause for the insufficient depth information from a result of the matching, and to further process the depth image depending on the determined cause.

### CROSS-REFERENCE TO RELATED APPLICATION

This application claims priority to German Patent Application Serial No. 10 2024 120 894.5, which was filed Jul. 23, 2024, and is incorporated herein by reference in its entirety.

### TECHNICAL FIELD

Aspects of the present disclosure generally relate to image processing systems and methods for processing camera images.

### BACKGROUND

Depth cameras based on stereo vision play an increasingly significant role in perception in robotics, ADAS (advanced driving assistance systems) and AD (autonomous driving). However, in order to achieve certified safety ratings such as SIL-2 or PL-d (SIL=safety integrity level, PL=performance level), a standard approach is to supplement depth cameras with additional 2D LiDAR sensors in order to provide a safety path.

A critical aspect for the safety certification of an image processing-based perception system is the rapid detection of circumstances or situations that affect the correct perception of the environment and the triggering of a warning signal or an automatic control command in response to such a circumstance or situation. Such circumstances or situations include, for example, the contamination of a camera lens or sensor by dust, liquid drops or scratches, but also scenes in which extreme contrast (wide dynamic range) leads to information loss or processing anomalies. Such information loss or such processing anomalies typically result in a lack of depth (e.g. in distance sensing systems such as a depth camera). If, for example, a safety-relevant object is not correctly detected due to lens contamination or a low-contrast region, this can lead to unsafe behavior of the particular system that uses the camera (e.g. a robot or vehicle).

It is therefore desirable to have image processing systems for the creation of depth images that quickly detect such circumstances or situations and react appropriately.

### BRIEF DESCRIPTION OF THE DRAWINGS

The figures do not reflect the actual proportions, but are intended to illustrate the principles of the various aspects of the present disclosure. In the following various aspects of the present disclosure are described with reference to the following figures.

FIG. 1 shows a vehicle according to an aspect of the present disclosure.

FIG. 2 illustrates the processing of images supplied by two light sensors by an image processing system according to one aspect of the present disclosure.

FIG. 3 illustrates bounding boxes for areas with missing depth information.

FIG. 4 illustrates the determination of the area corresponding to a relevant area of a depth image in an input image.

FIG. 5 shows an image processing system according to one aspect of the present disclosure.

FIG. 6 shows a flowchart illustrating a method for processing camera images according to an aspect of the present disclosure.

### DESCRIPTION

The following detailed description refers to the enclosed figures, which show details and aspects of the present disclosure. These aspects of the present disclosure are described in sufficient detail to enable the person skilled in the art to embody the invention. Other aspects of the present disclosure are also possible, and the aspects of the present disclosure can be modified in terms of their structural, logical and electrical aspects without deviating from the subject matter of the invention. The various aspects of the present disclosure are not necessarily mutually exclusive, but different aspects of the present disclosure may be combined to create new aspects of the present disclosure. For the purposes of this description, the terms “connected” and “coupled” are used to describe both a direct and an indirect connection, as well as a direct or indirect coupling.

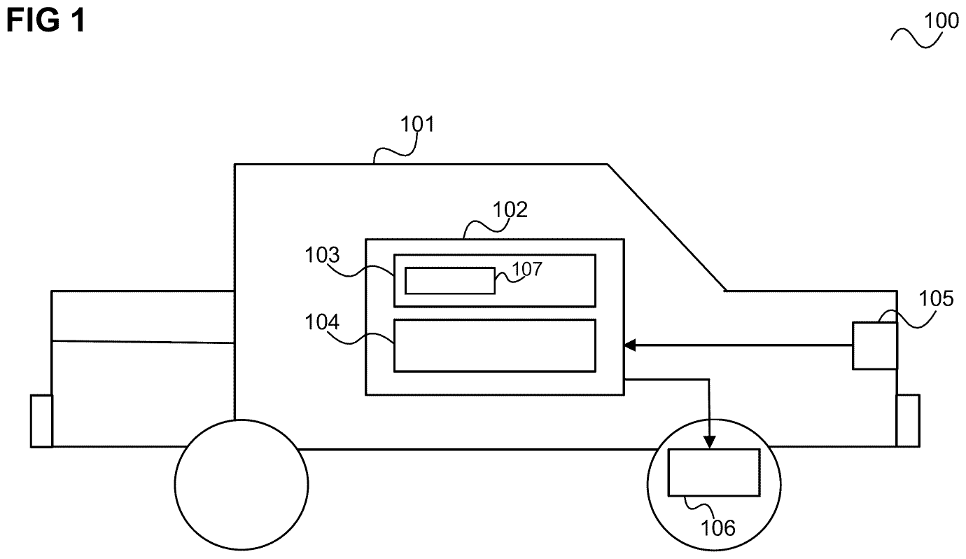

FIG. 1 shows a vehicle 101 (e.g. an autonomous vehicle).

In the example of FIG. 1, the vehicle 101, for example a passenger car or lorry, is provided with a vehicle control device 102.

The vehicle control device 102 has data processing components, e.g. a processor (e.g. a central processing unit, CPU) 103 and a memory 104 for storing control software, according to which the vehicle control device 102 operates, and data which is processed by the processor 103.

The data stored in the memory 104 can contain sensor data, for example, image data captured by one or more cameras 105. The vehicle control device 102 can then detect its environment on the basis of the sensor data, i.e. perform a perception function, for example determining, on the basis of the image data, in which lane the vehicle 101 is located and where other road users are present. Based on such a perception function, further processing can then be carried out up to outputting control signals for actuators 106 of the vehicle, e.g. a brake or a steering.

According to various aspects of the present disclosure, a plurality of cameras 105 are provided, by means of which a depth camera is implemented by means of stereo vision. A depth camera based on stereo vision (i.e. stereo view) is comparable to how human eyes function: two (or more) cameras (i.e. (light) sensors) are used at a fixed distance from each other to capture camera images of the same scene (a traffic scene in the example of the perception function for a vehicle control), which makes it possible to assign pixels from the images of the cameras to each other and to determine, by means of triangulation, where the objects represented by the pixels are in three-dimensional space (i.e. the environment of the vehicle, generally a robot device).

Contamination (of a lens) can affect both active light sensors (such as LiDAR sensors) and passive light sensors (such as cameras). However, while it is relatively easy for LiDAR sensors to detect impurities due to reduced intensity or non-returning radiation, it is much more difficult for (typically passive) cameras, i.e. light sensors that do not emit light but only use the available ambient light.

In addition to lens contamination, strong contrasts (i.e. a high dynamic range), e.g. due to retroreflective objects, can also lead to information loss. In the case of distance sensors (depth sensors) such as LiDAR or depth cameras, such situations can lead to missing (or at least insufficient) depth information, which can lead to objects not being recognized correctly or at all. In a camera, the respective exposure algorithm of the camera often compensates for the exposure (the amount of light captured) between dark and bright environments, which can result in underexposure or overexposure of certain areas at high contrast. This can of course be adjusted manually, but requires robust detection and sufficiently fast exposure adjustment.

A common approach to detecting contamination in light sensors is to collect a plurality of images while, for example, the vehicle or robot containing the light sensors is moving and then cross-correlate them to determine image areas that have a significantly lower variance (higher correlation) than other image areas over time. The underlying idea is that the scene (e.g. landscape) and thus the content of the images will change when the light sensor is mounted on a moving platform. However, since the contamination (e.g. of a lens) reduces the changes, the correlation between one image and the next is higher in case of contamination. Dirt, fluid and scratches on a lens can be reliably detected if the scene changes significantly enough over time.

However, a weakness in this approach is that the scene changes must be significant. In robotics and/or in a warehouse perception system, scene changes are often minimal even over long periods of time (e.g. several seconds). Sometimes light sensors are even mounted on a fixed mast, so even fewer changes can be expected. Therefore, there is a high risk that a temporal correlation-based detection approach such as the one mentioned above will not work if it is assumed that the respective detection system should detect lens contamination within a few seconds (typically less than 5 seconds=150 images for a camera that operates at 30 FPS).

According to various aspects of the present disclosure, in view of the above, an image processing system having a detection mechanism for stereo-based depth cameras is provided in order to be able to detect situations in which lens contamination and/or extreme contrasts are present and thus, for example, to be able to meet applicable safety requirements in robotics. The detection mechanism uses a cross correlation of data between two (or more) light sensors (a stereo-based depth camera) to detect such situations.

Unlike the temporal correlation-based detection approach mentioned above, the provided detection mechanism requires only a single image to detect potential contamination and less than ten images with temporal filtering to avoid false alarms.

In addition, according to various aspects of the present disclosure, the image processing system is able to perform a distance estimation in high contrast situations in order to directly estimate and thus supplement missing depth information (without the need for an exposure adjustment).

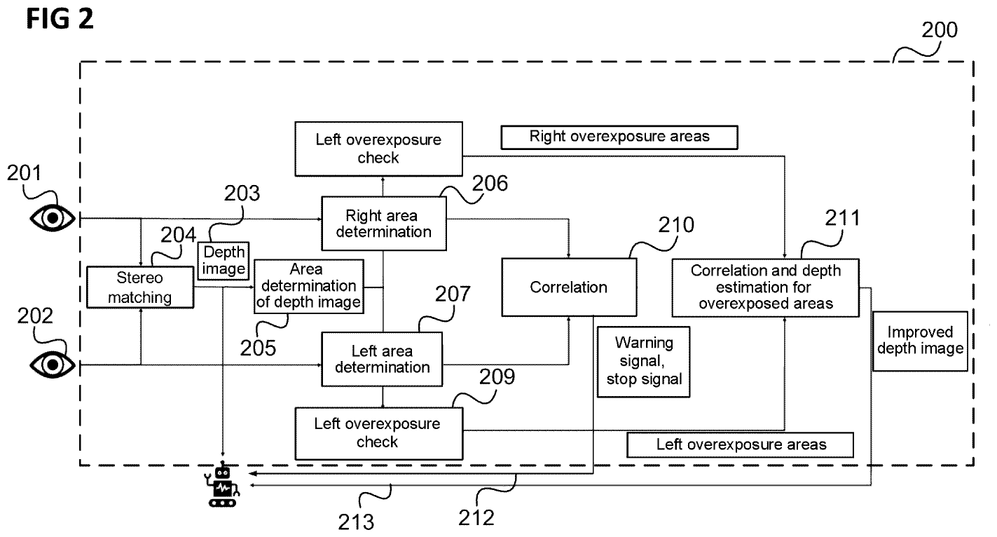

FIG. 2 illustrates a processing of (input) images (e.g. a left and a right image) supplied by two light sensors 201, 202 by an image processing system 200 according to an aspect of the present disclosure.

In addition to creating a depth image 203 by stereo image matching 204, the image processing system 200 performs the following:
1) determining (depth image) areas in the depth image 203 with missing depth information in 205 (so-called “relevant” (depth image areas))
2) searching for corresponding (relevant input image) areas in each input image (e.g. in the left and right input image) in 206 or 207
3) checking the determined input image areas for overexposure in 208 or 209
4) correlating the determined input image areas in 210
5) estimating the depth of overexposed input image areas and providing an updated depth image in 211
6) robot interaction, e.g. if necessary, issuing a warning to the robot (or a vehicle) or stopping the robot (or vehicle) in 212 or outputting the depth image or updated depth image to a control device of the robot (or vehicle) in 213.

The above operations 1) to 6) are explained in detail below. In the following examples, it is assumed that the two light sensors 201, 202 belong to a (classic) stereo view camera, which provides the depth image 203 as an output, i.e. a camera with the two light sensors 201, 202, which provide camera images (hereinafter referred to as input images), for which a stereo matching is carried out to obtain a depth image with a distance for each pixel. The approach described herein can also be applied to cameras with more than two light sensors. The light sensors 201, 202 can be of RGB, grayscale or infrared type. When reference is made herein to a robot, this is an example, and the operation in question can also refer in general to a robot device of a different type, such as a vehicle.

1) Determining (Depth Image) Areas in the Depth Image 203 with Missing Depth Information

In this case, the image processing system 200 uses the depth image 203 as input and determines all relevant areas of the depth image where the depth information is missing (or at least insufficient). Since stereo cameras often provide missing depth at the edges of objects, because only one light sensor 201, 202 (left or right) can see a respective edge correctly, there are often several areas with missing depth in a given depth image. The image processing system 200 therefore identifies the depth image areas and excludes those that belong to the edges of an object.

For this purpose, the image processing system 200 converts the depth image 203 into a binary mask. It then processes the mask using a morphological operation such as erosion and dilation to remove irrelevant determined areas. Then the image processing system 200 clusters the remaining determined areas, removes small determined areas (whose size is below a predetermined threshold value), and determines, for each remaining determined area (hereinafter referred to as the “relevant (depth image) area”), a convex envelope (or a simple bounding polygon) that encloses the area.

Since the remaining determined areas are used in the further operations, handling convex envelopes (or boundary polygons) can be computationally intensive. Therefore, according to one aspect of the present disclosure, the image processing system 200 creates a simple bounding box for each relevant area (i.e., represents it as a bounding box). In this case, the removal of small areas takes place, for example, based on the size of the bounding boxes. The result in this case is a set of relevant (depth image) areas R that can be written as

$$R = \{ r \vert r = \{ x , y , w , h \} with w \times h > t \}$$

where x and y are the pixel coordinate of one of the corners of the relevant arear, w and h are the corresponding width and height of the bounding box that describe it, wherein the area must be larger than a threshold value t.

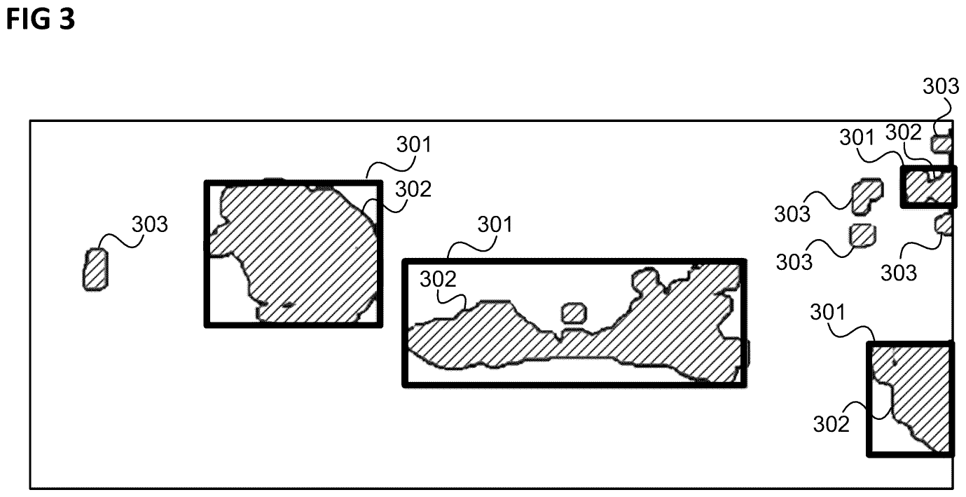

FIG. 3 illustrates the bounding box 301 (with a specified minimum size) for areas 302 of the depth image with missing depth information. Additional areas 303 with missing depth information were ignored due to their small size, i.e. they are not considered relevant areas.

2) Searching for Corresponding (Input Image) Areas of the Input Image in Each Input Image (e.g. In the Left and Right Input Image)

The corresponding areas in the input images are determined for each relevant (depth image) area.

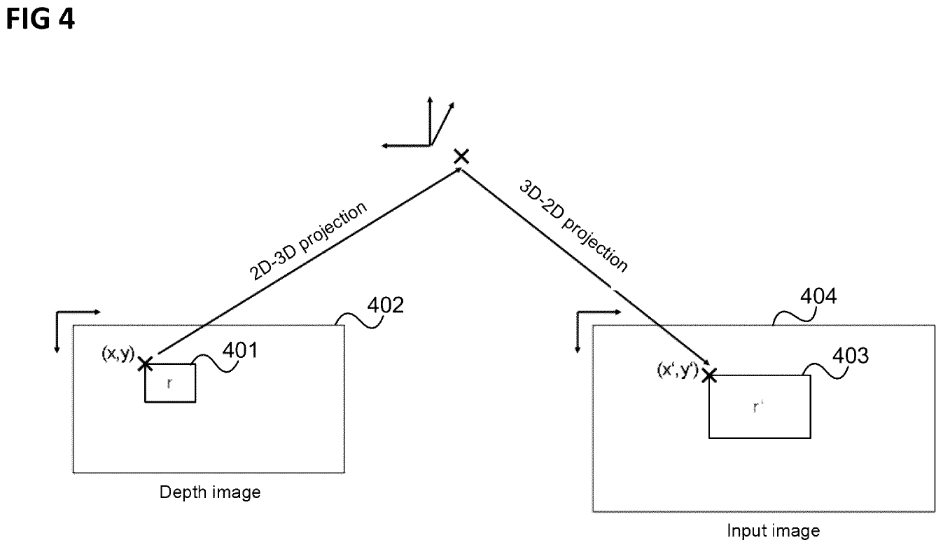

FIG. 4 illustrates the determination of an area 403 (denoted by r′) corresponding to a relevant area 401 (denoted by r) of the depth image 402 in one of the input images 404.

The determination is made by means of projecting pixels that describe the region r, e.g. the bounding box corner point (x, y) in the 3D space, in order to find the real coordinates, i.e. the coordinates of the points in the object space, which are shown by these pixels. The image processing system 200 then transforms these coordinates to take into account a possible shift of the depth origin to the origin of the input image 404 (i.e. the corresponding light sensor). Finally, the image processing system 200 performs a back projection into the image plane of the respective light sensor (sensor plane) to obtain the equivalent pixel coordinates of the light sensor, for example, the coordinates (x′, y′) in the input image 404, which correspond to the boundary box corner point (x, y) in the depth image 402.

In other words: The image processing system 200 determines a relevant input image area rᵢ′ for each relevant (depth image) area r∈R, wherein i indicates the input image (e.g. left or right). This provides a number Rᵢ′ of relevant input image areas. Each input image area

$${r}_{i}^{′} = \{ {x}_{i}^{′} , {y}_{i}^{′} , {w}_{i}^{′} , {h}_{i}^{′} \}$$

can have a different width and height than the corresponding depth image area (from which it was determined), if the resolution of the input images of the depth image 203 is different.

Note that the corner(s) of a bounding box (which describes a relevant depth image area) can fall onto pixels in the depth image with missing information. In this case, no projection into 3D space is possible. Therefore, it can be provided that the image processing system in such a case extends the bounding box in such a way that at least the corner (x, y) falls on a valid depth pixel (that is, one with depth information). This can be achieved by moving the pixel to the left (smaller x) or up (smaller y). If this means that the pixel falls on the edge of the image, the projection can be performed very easily (e.g. x=0=x′).

### 3) Checking the Determined (Relevant) Input Image Areas for Overexposure

Here, it is determined for each determined relevant input image area

$${r}_{i}^{′}$$

whether it is significantly overexposed. If the respective input image is an RGB image, the image processing system 200 converts the image into a greyscale image. If the input image has only one channel (e.g. an infrared image), this conversion is not required. In the greyscale image, overexposure is manifested in pixels that have the maximum possible value, for example, 255 if it is a 8-bit greyscale image. Based on this, the image processing system 200 can create a binary mask that captures the overexposed parts. Similar to determining the relevant depth image areas (see above), the image processing system 200 applies a morphological transformation with erosion and dilation to remove small areas of oversaturation (for example, by an infrared pattern in an infrared camera, or small reflections on objects in RGB cameras). The image processing system 200 then represents the remaining overexposed areas (such as the relevant depth image areas) as an enclosing polygon (convex envelope) or as a simple bounding box. If the overexposed area is sufficiently large (for example, covers most of the input image area), the image processing system will mark the entire input image area r′ as overexposed.

### 4) Correlating the Determined Input Image Areas

Since the areas corresponding to the relevant depth image areas are present in both input images, the image processing system 200 now relates them to each other. For example, for a relevant depth image area

$${r}_{left}^{′} ,$$

the corresponding area in the first (left) input image and the corresponding area in the second (right) input image

$${r}_{right}^{′}$$

should now be used.

First, the image processing system 200 checks whether the lens of the left or right light sensor 201, 202 has impurities in the areas

$${r}_{left}^{′} and {r}_{right}^{′} .$$

For this purpose, it uses the smaller of the two input image areas as a template and compares them with the larger of the two input image areas. If both are the same size, the image processing system 200 can use any of the two areas as a template. The matching of the two areas provides a correlation score:

$$correlation score = M ( {r}_{left}^{′} , {r}_{right}^{′} )$$

The area matching metric M to determine the correlation value (i.e. how well the area used as a template is represented in the other input image area) can be performed, for example, with freely available libraries such as OpenCV (Open Source Computer Vision Library). The higher the correlation value, the better the match between the two input image areas. A low correlation value indicates that there is a problem in one of the two input image areas, which should ideally be identical, or in the respective light sensor 201, 202. This is interpreted by the image processing system 200 as an indication of lens contamination.

The image processing system 200 can use different approaches for the matching with the template, including an AI (artificial intelligence)-supported evaluation (e.g. neural networks, and/or learning-based), although classic approaches can also be used by the image processing system 200 for the matching such as the comparison of mean and variance of

$${r}_{left}^{′} and {r}_{right}^{′} .$$

In addition, the image processing system 200 can also use (pixel by pixel) cross-correlation coefficients as a form of matching. The various approaches differ depending on how well the light regions with problems (due to contamination) can be distinguished from light regions without problems.

It should be noted that a single pair of input images of the two light sensors 201, 202 is sufficient to carry out the matching and thus the contamination check, which is a significant advantage over time-based contamination tests, which require hundreds of images. However, it may happen that from time to time a contamination is incorrectly detected, i.e. a low correlation value is calculated, even though no contamination is present. This can happen, for example, if an object is only detected by one of the two light sensors 201, 202. However, this can be easily remedied by tracking contamination detection across a plurality of images with the image processing system 200: contamination results in a low score in every input image of a light sensor, while false low scores typically occur only from time to time and disappear quickly. Thus, an aggregation of three input image pairs is sufficient in order to detect (and dismiss) false contamination detection as such.

### 5) Estimating the Depth of Overexposed Input Image Areas and Providing an Updated Depth Image

In the case of an overexposed input image

$$a r e a {r}_{i}^{′} ,$$

the image processing system 200 not only performs the correlation to check whether the lack of depth information has been caused by contamination. If it does not detect contamination, it can calculate a distance estimate for the overexposed object. It can use the bounding box of the determined overexposed area (see 3 above) to perform a stereo matching between the input image and the input image of the other light sensor (just as it does to determine the depth image 203 if there are no problems). Thus, the image processing system 200 can, for example, perform a triangulation for corners (or the center) of the bounding box of the overexposed area to determine the distance of the (luminous) object causing the overexposure. The image processing system 200 can then use this depth estimation to fill in the missing depth information for the input image area

$${r}_{i}^{′}$$

(i.e. in the corresponding area r of the depth image). Alternatively or in addition, the image processing system 200 can also use the depth estimation to perform direct safety checks as follows.

It should be noted that the same procedure for overexposed objects can be used analogously for underexposed objects. An underexposure manifests itself in the grayscale image in pixels that have the minimum possible value, typically 0. In 3), therefore, checking the determined (relevant) input image areas for underexposure can be performed and in 5) depth information for underexposed objects can be supplemented.

### 6) Robot Interaction

When an overexposed object or lens contamination is detected, the image processing system 200 informs, for example, the user of the robot or even stops the robot under certain conditions. For example, it forwards the results of the lens contamination and overexposure test directly to a robot safety system (or control system). Additionally, the estimated distance for each overexposed object can be specified to only force a stop if the object is at a relevant distance.

In the event that an overexposure is detected, the image processing system 200 can carry out an additional action, namely adjusting the exposure settings of the light sensors. When the image processing system 200 detects such a situation, it can immediately reduce the exposure time to improve depth coverage for the subsequent images. However, in high contrast situations, this can cause other areas of the image to be underexposed. Therefore, the image processing system 200 uses a type of HDR (high dynamic range) photography. This means that after an overexposed area is detected, the next image is captured with a shorter exposure time. This will achieve (through this next image) better depth coverage of the overexposed object in the overexposed area r. The image processing system 200 then uses the depth information obtained in this way (from the next image) and can merge it with that of the previous depth image (for which the depth information in the overexposed area is missing) in order to create a depth image with complete depth information and to prevent underexposed areas becoming a problem. This requires careful fusion when the light sensors are mounted on a moving platform, but is relatively simple for stationary light sensors. Fusion allows the image processing system 200 to directly provide higher-quality sensor data, which is useful for all processing elements that use the sensor data (in this case depth images). However, the effective frame rate is reduced because the image processing system 200 combines two images until it can provide a depth image.

Similarly, in the event that an underexposure is detected (with the “opposite” measures: the exposure time for the subsequent images is increased instead of decreased, etc.).

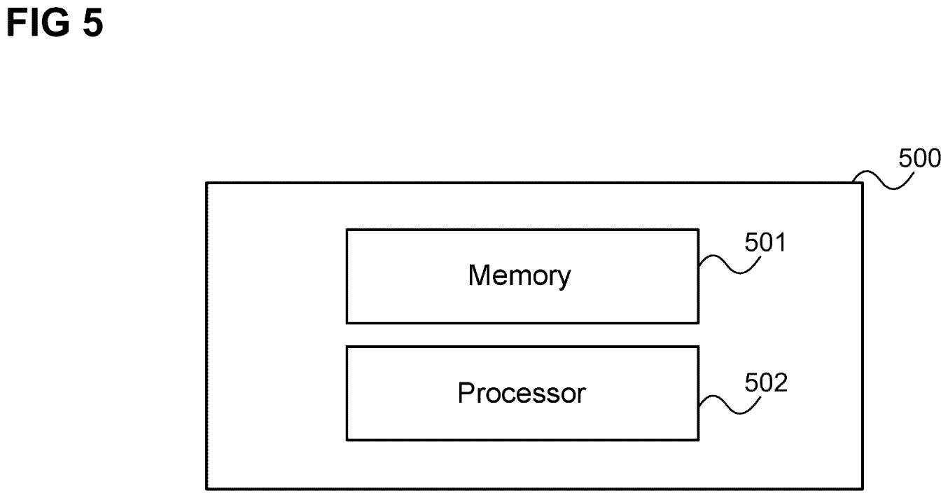

In summary, according to various aspects of the present disclosure, an image processing system is provided as described below with reference to FIG. 5.

FIG. 5 shows an image processing system 500 according to an aspect of the present disclosure.

The image processing system 500 has a memory 501 and a processor 502, wherein the processor is configured,
to determine a depth image from at least two camera images of a scene;
to determine at least one area in the depth image where depth information is insufficient (e.g. missing, that is where the processor could not obtain depth information);
for the at least one determined area in the depth image where depth information is insufficient, (i.e. for the one determined area of the depth image or for each area of the depth image if a plurality of areas have been determined)
   for each of the at least two camera images, determine a camera image area of the camera image that corresponds to the determined area in the depth image where depth information is insufficient;
   to perform a matching of at least parts of the determined camera image areas (which correspond to the area in the depth image where depth information is insufficient and which belong to different camera images); and
   to determine a cause for the insufficient (e.g. missing) depth information from a result of the matching; and
   to further process the depth image depending on the determined cause (if necessary on the several determined causes, if the processor has determined several areas in the depth image where depth information is insufficient).

In other words, according to various aspects of the present disclosure, an image processing system (e.g. as a security system to meet safety requirements for a vehicle or robot) for stereo-vision-based (i.e. stereo image processing) depth cameras is provided, which is capable of detecting lens contamination and extreme contrasts by correlating image areas corresponding to an area in the depth image with missing (or at least insufficient) depth information. According to various aspects of the present disclosure
the image processing system makes it possible to quickly detect lens contamination (within a single image) by correlating areas of the images from two or more light sensors used for stereo vision
the image processing system makes it possible to quickly detect situations with extreme (critical) contrast (within a single image) by correlating areas of both image sensors used for stereo vision
the image processing system fills in insufficient (e.g. missing) depth information in high contrast situations
the image processing system enables a higher degree of security (e.g. a vehicle or robot) by alerting a user or forcing a stop when critical events are detected
the detection mechanism used by the image processing system does not require temporal correlation to detect impurities or high contrast, making the image processing system suitable for stationary security applications.

The image processing system can be used in all areas where improved depth quality and robust detection of (safety) critical situations due to high contrast or lens contamination are important. For example, it can be installed directly in a depth camera.

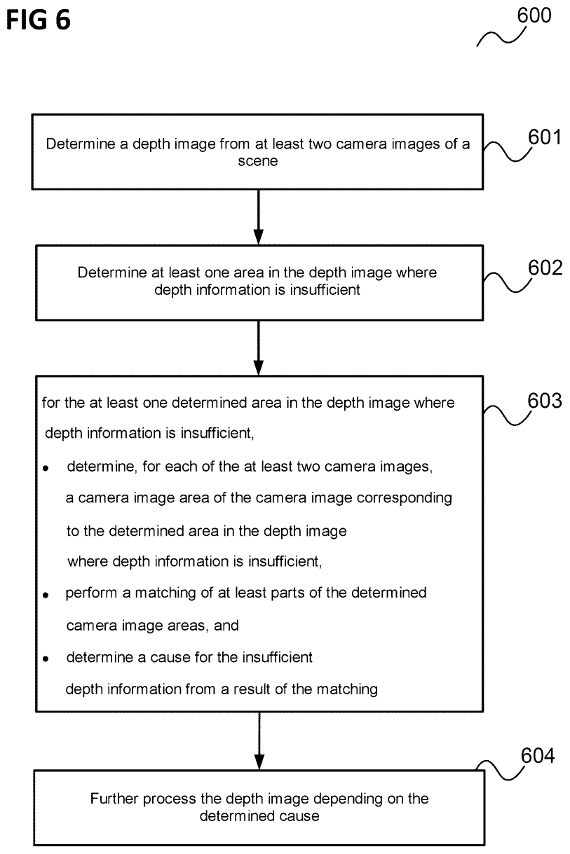

According to various aspects of the present disclosure, an image processing system (which, for example, is part of a perception system of a control system for a robot device such as an assisted or autonomous vehicle or a robot) performs a method as shown in FIG. 6.

FIG. 6 shows a flowchart 600, illustrating a method for processing camera images according to an aspect of the present disclosure.

In 601, a depth image is determined from at least two camera images of a scene.

At least one area in the depth image where depth information is insufficient is determined in 602;

In 603, for the at least one determined area in the depth image where depth information is insufficient, (i.e. for the one determined area of the depth image or for each area of the depth image if a plurality of areas have been determined) a camera image area corresponding to the determined area in the depth image where depth information is insufficient is determined for each of the at least two camera images, a matching of at least parts of the determined camera image areas is performed, and a cause for the insufficient depth information is determined from a result of the matching.

In 604, the depth image is further processed depending on the determined cause (or causes).

### Various Aspects of the Present Disclosure are Specified Below

Example 1 is an image processing system including: a memory and a processor, wherein the processor is configured to determine a depth image from at least two camera images of a scene, to determine at least one area in the depth image where depth information is insufficient, for the at least one determined area in the depth image where depth information is insufficient (i.e. for the one determined area or for each of the determined areas if a plurality of areas were determined), to determine, for each of the at least two camera images, a camera image area of the camera image that corresponds to the determined area in the depth image where depth information is insufficient, to perform a matching of at least parts of the determined camera image areas, to determine a cause for the insufficient depth information from a result of the matching, and to further process the depth image depending on the determined cause.

Example 2 is an image processing system according to Example 1, wherein determining the cause for the insufficient depth information from a result of the matching includes detecting a camera contamination from the result of the matching.

Example 3 is an image processing system according to Example 2, wherein the matching includes a camera image area matching of the determined camera image areas, and wherein the result of the matching includes a camera image area match score describing a degree of match of the determined camera image areas, and wherein the processor is configured to determine that the cause is a camera contamination if the camera image area match score is below a predetermined threshold value.

Example 4 is an image processing system according to Example 2 or 3, wherein the further processing of the depth image includes outputting an alarm signal or an automatic control command depending on the detected cause, in response to the processor ascertaining that the cause is a camera contamination.

Example 5 is an image processing system according to any one of the examples 2 to 4, wherein the further processing of the depth image depending on the determined cause, in response to the processor ascertaining that the cause is a camera contamination, includes the processor determining whether it also ascertains camera contamination for subsequent camera images and further processing the depth image depending on whether it also ascertains camera contamination for subsequent camera images.

Example 6 is an image processing system according to any one of the examples 1 to 5, wherein the processor is configured to determine whether overexposure areas are present in the determined camera image areas, and wherein the processor is configured, in response to determining that overexposure areas are present in the determined camera image areas, to determine the overexposure regions, and the matching includes an overexposure area matching of the determined overexposure areas (which belong to different camera images of the camera images).

Example 7 is an image processing system according to Example 6, wherein the result of the matching includes an overexposure area match score describing a degree of match of the determined overexposure areas, and wherein the processor is configured to determine that the cause is a luminous object if the overexposure area match score is above a predetermined threshold value.

Example 8 is an image processing system according to Example 7, wherein the further processing of the depth image depending on the determined cause in response to the processor ascertaining that the cause is a luminous (i.e. self-luminous or reflective) object includes determining a position of the luminous object and supplementing depth information corresponding to the determined position of the luminous object in the depth image.

Example 9 is an image processing system according to Example 8, wherein the processor is configured to determine the position of the luminous object on the basis of the position of the determined overexposure areas in the at least two camera images.

Example 10 is an image processing system according to one of the examples 6 to 9, wherein the further processing of the depth image depending on the determined cause in response to the processor ascertaining that the cause is a luminous (i.e. self-luminous or reflective) object includes reducing the exposure time of at least two cameras, by means of which the at least two camera images were recorded, and fusing the depth image with a further depth image determined by the processor from further camera images of the scene subsequently recorded by means of the at least two cameras.

Example 11 is an image processing system according to any one of the examples 1 to 10, wherein the processor is configured to determine whether underexposure areas are present in the determined camera image areas, and wherein the processor is configured, in response to ascertaining that underexposure areas are present in the determined camera image areas, to determine the underexposure areas, and the matching includes an underexposure area matching of the determined underexposure areas (which belong to different camera images of the camera images).

Example 12 is an image processing system according to Example 11, wherein the result of the matching includes an underexposure area match score describing a degree of match of the determined underexposure areas, and wherein the processor is configured to determine that the cause is an underexposed object if the underexposure area match score is above a predetermined threshold value.

Example 13 is an image processing system according to Example 12, wherein the further processing of the depth image depending on the determined cause in response to the processor ascertaining that the cause is an underexposed object includes determining a position of the underexposed object and supplementing depth information corresponding to the determined position of the underexposed object in the depth image.

Example 14 is an image processing system according to any one of the examples 1 to 13, wherein the processor is configured, when determining the at least one area in the depth image where depth information is insufficient, to exclude areas in the depth image where depth information is insufficient but whose size is below a predetermined minimum size.

Example 15 is an image processing system according to any one of the examples 1 to 14, wherein the further processing of the depth image depending on the determined cause includes generating input data for a system expecting the depth image as input depending on the determined cause.

Example 16 is an image processing system according to Example 15, wherein the system expecting the depth image as input is a control system for a robot device.

Example 17 is an image processing system according to any one of the examples 1 to 16, wherein the processor is configured to perform the matching based on artificial intelligence (and so in particular to determine, for example, an AI-based evaluation).

Example 18 is a robot device (e.g. a robot or an assisted or autonomous vehicle) having an image processing system according to any one of the examples 1 to 17.

Example 19 is a method for processing camera images, including determining a depth image from at least two camera images of a scene, determining at least one area in the depth image where depth information is insufficient, for the at least one determined area in the depth image where depth information is insufficient, determining, for each of the at least two camera images, a camera image area of the camera image corresponding to the determined area in the depth image where depth information is insufficient, performing a matching of at least parts of the determined camera image areas, determining a cause for the insufficient depth information from a result of the matching, and further processing the depth image depending on the determined cause.

Further examples are a computer program element and a computer readable memory medium, which have commands that, when executed by a processor, cause the processor to perform the method for processing camera images.

It should be noted that the features described in connection with examples of the image processing system can also be applied analogously to the method for processing camera images.

Although the invention has mainly been shown and described by reference to specific aspects of the present disclosure, it should be understood by those familiar with the technical field that numerous changes can be made with regard to its design and details without departing from the nature and scope of the invention, as defined by the following claims. The scope of the invention is therefore defined by the attached claims and it is intended that any changes that fall within the literal meaning or equivalent scope of the claims are included.

1. An image processing system, comprising:
A memory and a processor, whereby the processor is configured,
to determine a depth image from at least two camera images of a scene;
to determine at least one area in the depth image where depth information is insufficient;
for the at least one determined area in the depth image where depth information is insufficient,
for each of at least two camera images, determine a camera image area of the camera image that corresponds to the determined area in the depth image where depth information is insufficient;
perform a matching of at least parts of the determined camera image areas;
determine a cause for the insufficient depth information from a result of the matching; and
further process the depth image depending on the cause determined.

2. The image processing system according to claim 1, wherein determining the cause of the insufficient depth information from a result of the matching comprises detecting a camera contamination from the result of the matching.

3. The image processing system according to claim 2, wherein the matching comprises a camera image area matching of the detected camera image areas, and wherein the result of the matching comprises a camera image area match score describing a degree of match of the detected camera image areas, and wherein the processor is arranged to determine that the cause is camera contamination if the camera image area match score is below a predetermined threshold.

4. The image processing system according to claim 2, wherein the further processing of the depth image comprises outputting an alarm signal or an automatic control command depending on the detected cause, in response to the processor detecting that the cause is camera contamination.

5. The image processing system according to claim 2, wherein further processing the depth image depending on the determined cause, in response to the processor determining that the cause is camera contamination, comprises the processor determining whether it also determines camera contamination for subsequent camera images and further processing the depth image depending on whether it also determines camera contamination for subsequent camera images.

6. The image processing system according to claim 1, wherein the processor is arranged to determine whether overexposure areas are present in the determined camera image areas, and wherein the processor is arranged, in response to determining that overexposure areas are present in the determined camera image areas, to determine the overexposure areas, and the adjustment comprises an overexposure area adjustment of the determined overexposure areas.

7. The image processing system according to claim 6, wherein the result of the matching comprises an overexposure area match score describing a degree of match of the detected overexposure areas, and wherein the processor is arranged to determine that the cause is a luminous object if the overexposure area match score is above a predetermined threshold value.

8. The image processing system according to claim 7, wherein further processing the depth image depending on the determined cause in response to the processor determining that the cause is a luminous object comprises determining a position of the luminous object and supplementing depth information corresponding to the determined position of the luminous object in the depth image.

9. The image processing system according to claim 8, wherein the processor is configured to determine the position of the luminous object on the basis of the position of the determined overexposure areas in the at least two camera images.

10. The image processing system according to claim 6, wherein further processing the depth image depending on the determined cause in response to the processor determining that the cause is a luminous object comprises reducing the exposure time of at least two cameras used to take the at least two camera images, and fusing the depth image with a further depth image determined by the processor from further camera images of the scene subsequently taken using the at least two cameras.

11. The image processing system according to claim 1, wherein the processor is arranged to determine whether underexposure areas are present in the determined camera image areas, and wherein the processor is arranged, in response to determining that underexposure areas are present in the determined camera image areas, to determine the underexposure areas, and the adjustment comprises an underexposure area adjustment of the determined underexposure areas.

12. The image processing system according to claim 11, wherein the result of the matching comprises an underexposure area match score describing a degree of match of the detected underexposure areas, and wherein the processor is arranged to determine that the cause is an underexposed object if the underexposure area match score is above a predetermined threshold.

13. The image processing system according to claim 12, wherein further processing the depth image depending on the determined cause in response to the processor determining that the cause is an underexposed object comprises determining a position of the underexposed object and adding depth information corresponding to the determined position of the underexposed object in the depth image.

14. The image processing system according to claim 1, wherein the processor is arranged, when determining the at least one area in the depth image at which depth information is insufficient, to exclude areas in the depth image at which depth information is insufficient but whose size is below a predetermined minimum size.

15. The image processing system according to claim 1, wherein further processing the depth image depending on the determined cause comprises generating input data for a system expecting the depth image as input depending on the determined cause.

16. The image processing system according to claim 1, wherein the image processing system is implemented as a robot, an assisted vehicle, or an autonomous vehicle.

17. A method for processing camera images, comprising:
Determining a depth image from at least two camera images of a scene;
Determining at least one area in the depth image where depth information is insufficient;
for the at least one determined area in the depth image where depth information is insufficient,
Determining, for each of the at least two camera images, a camera image area of the camera image corresponding to the determined area in the depth image at which depth information is insufficient;
Carrying out a matching of at least parts of the determined camera image areas;
Determining a cause of the insufficient depth information from a result of the matching; and
Further processing of the depth image depending on the cause determined.

18. The method according to claim 17, wherein determining the cause of the insufficient depth information from a result of the matching comprises detecting a camera contamination from the result of the matching.

19. A non-transitory computer readable storage medium comprising instructions which, when executed by a processor, cause the processor to
Determine a depth image from at least two camera images of a scene;
Determine at least one area in the depth image where depth information is insufficient;
for the at least one determined area in the depth image where depth information is insufficient,
Determine, for each of the at least two camera images, a camera image area of the camera image corresponding to the determined area in the depth image at which depth information is insufficient;
Carry out a matching of at least parts of the determined camera image areas;
Determine a cause of the insufficient depth information from a result of the matching; and
Further process of the depth image depending on the cause determined.

20. The non-transitory computer readable storage medium according to claim 19, wherein determining the cause of the insufficient depth information from a result of the matching comprises detecting a camera contamination from the result of the matching.
